(19) United States
(12) Patent Application Publication
(10) Pub. No.: US 2026/0369912 A1
(43) Pub. Date: Nov. 19, 2026

(54) LOW-PROFILE CHARGING INLET ASSEMBLY

(71) Applicant: TE Connectivity Solutions GmbH, Schaffhausen (CH)

(72) Inventors: Kevin John PETERSON, Winston Salem, NC (US); Matthew Bryan HITCHCOCK, Middletown, PA (US); Joshua T. SHOEMAKER, Winston Salem, NC (US); Mithun HEBBAR, Bangalore (IN)

(21) Appl. No.: 19/377,393

(22) Filed: Nov. 3, 2025

Related U.S. Application Data
(60) Provisional application No. 63/806,791, filed on May 16, 2025.

(30) Foreign Application Priority Data
Aug. 19, 2025 (IN) 202541078622

(51) Int. Cl. H01R 13/424; H01R 13/66

(52) U.S. Cl. CPC H01R 13/424; H01R 13/665; H01R 2201/26

(57) ABSTRACT

A charging inlet assembly includes a housing extending between a front and a rear. The housing has a depth between the front and the rear. The housing defines a receptacle connector at the front configured for mating reception of a charging connector. The housing has terminal channels holding terminals of a terminal assembly coupled to the housing. Each terminal includes a base and a pin extending forward from the base. The charging inlet assembly includes a control module electrically coupled to the terminal assembly. The control module includes a connector housing coupled to the housing and contained within the depth of the housing located rearward of the front and forward of the rear of the housing.

### CROSS REFERENCE TO RELATED APPLICATIONS

### This application claims priority to US Application No. 63/806,791, filed 16-May-2025, and IN Application No. 202541078622, filed 19-Aug. 2025, the subject matter of which is herein incorporated by reference in its entirety.

### BACKGROUND OF THE INVENTION

The subject matter herein relates generally to charging inlet assemblies.

In order to charge a battery of an electric vehicle (EV) or hybrid electric vehicle (HEV), the vehicle is provided with a charging inlet assembly. A charging connector is configured to be mated with the charging inlet assembly. Terminals are held in a receptacle connector of a housing of the charging inlet assembly. The terminals extend through channels in the housing into a chamber at the rear of the housing for connection to corresponding power cables or other connectors. Typically, the power cables and the connectors extend rearwardly from the charging inlet. However, some vehicles have limited space in the vehicle for the charging inlet assembly, such as behind the charging inlet assembly.

The subject matter herein relates generally to charging inlet assemblies.

### BRIEF DESCRIPTION OF THE INVENTION

In one embodiment, a charging inlet assembly is provided and includes a housing extending between a front and a rear. The housing has a depth between the front and the rear. The housing defines a receptacle connector at the front configured for mating reception of a charging connector. The housing has a chamber at the rear. The housing has terminal channels between the front and the rear. The charging inlet assembly includes a terminal assembly coupled to the housing. The terminal assembly includes a plurality of terminals for mating with charging terminals of the charging connector. The terminals are received in corresponding terminal channels. Each terminal includes a base and a pin extending forward from the base. The charging inlet assembly includes a control module electrically coupled to the terminal assembly. The control module includes a connector housing coupled to the housing. The control module is contained within the depth of the housing located rearward of the front and forward of the rear of the housing.

IIn another embodiment, a charging inlet assembly is provided and includes a housing extending between a front and a rear. The housing has a depth between the front and the rear. The housing defines a receptacle connector at the front configured for mating reception of a charging connector. The housing has a chamber at the rear. The housing has terminal channels between the front and the rear. The charging inlet assembly includes a terminal assembly coupled to the housing. The terminal assembly includes a plurality of terminals for mating with charging terminals of the charging connector. The terminals are received in corresponding terminal channels. Each terminal includes a base and a pin extending forward from the base. The terminal assembly includes a printed circuit board. The bases of the terminals are coupled to the printed circuit board. The terminal assembly includes mating contacts extending from the printed circuit board. The charging inlet assembly includes a control module electrically coupled to the terminal assembly. The control module includes a connector housing that holds control contacts. The connector housing coupled to the housing. The control contacts coupled to the corresponding mating contacts to electrically connect to the printed circuit board. The control module contained within the depth of the housing located rearward of the front and forward of the rear of the housing.

In a further embodiment, a charging inlet assembly is provided and includes a housing extending between a front and a rear. The housing includes a rear cover coupled to and covering the rear of the housing. The housing includes a mounting flange at the front of the housing configured to be mounted to a vehicle. The housing defines a receptacle connector at the front configured for mating reception of a charging connector. The housing has a chamber at the rear. The housing has terminal channels between the front and the rear. The charging inlet assembly includes a terminal assembly coupled to the housing. The terminal assembly includes a plurality of terminals for mating with charging terminals of the charging connector. The terminals are received in corresponding terminal channels. Each terminal includes a base and a pin extending forward from the base. The charging inlet assembly includes a control module electrically coupled to the terminal assembly. The control module includes a connector housing coupled to the housing. The control module is located between the mounting flange and the rear cover.

### BRIEF DESCRIPTION OF THE DRAWINGS

FIG. 1 is a front view of a charging inlet assembly in accordance with an exemplary embodiment.

FIG. 2 is a rear perspective view of the charging inlet assembly in accordance with an exemplary embodiment.

FIG. 3 is a sectional view of the charging inlet assembly in accordance with an exemplary embodiment.

FIG. 4 is an exploded view of the charging inlet assembly in accordance with an exemplary embodiment.

FIG. 5 is an exploded, partially assembled view of the charging inlet assembly in accordance with an exemplary embodiment.

FIG. 6 is a rear perspective view of a portion of the charging inlet assembly in accordance with an exemplary embodiment.

FIG. 7 is a sectional view of the charging inlet assembly shown in FIG. 6 in accordance with an exemplary embodiment.

FIG. 8 is a rear perspective view of a portion of the charging inlet assembly in accordance with an exemplary embodiment.

FIG. 9 is a sectional view of the charging inlet assembly shown in FIG. 8 in accordance with an exemplary embodiment.

FIG. 10 is a rear perspective view of a portion of the charging inlet assembly in accordance with an exemplary embodiment.

### DETAILED DESCRIPTION OF THE INVENTION

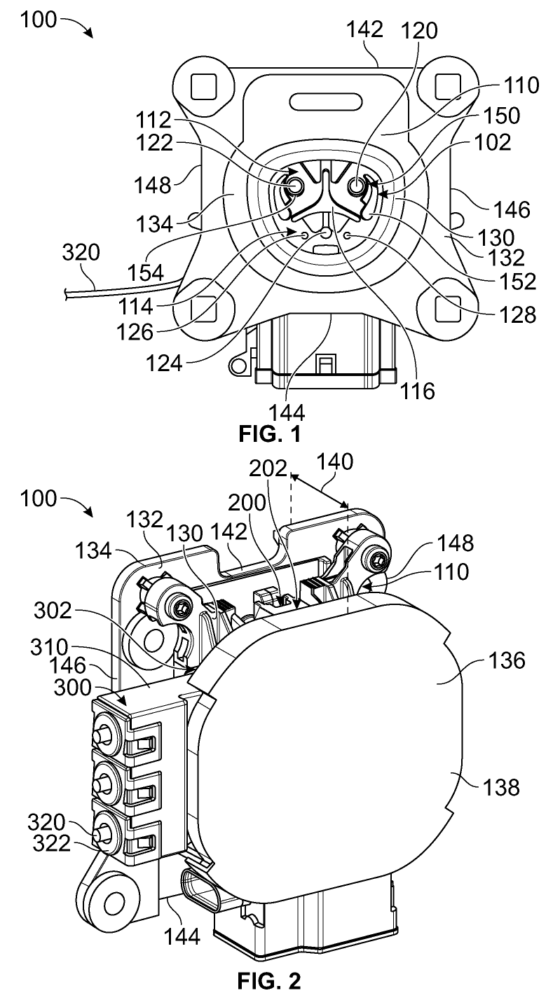

FIG. 1 is a front view of a charging inlet assembly 100 in accordance with an exemplary embodiment. FIG. 2 is a rear perspective view of the charging inlet assembly 100 in accordance with an exemplary embodiment. The charging inlet assembly 100 is used as a charging inlet for a vehicle, such as an electric vehicle (EV), hybrid electric vehicle (HEV), or plug-in hybrid electric vehicles (PHEVs). In an exemplary embodiment, the charging inlet assembly 100 is a low-profile charging inlet assembly having a limited depth dimension for use in a vehicle having clearance requirements, such as behind the charging inlet assembly 100.

The charging inlet assembly 100 includes a receptacle connector 102 configured for mating reception with a charging connector (not shown). In an exemplary embodiment, the receptacle connector 102 is configured for mating with an AC charging connector, such as SAE J3400. The receptacle connector 102 may be configured for mating with other types of charging connectors associated with other standards, including for mating with a DC fast charging connector, such as the SAE combo CCS charging connector, the SAE J1772 charging connector, the North American Charging System (NACS), or other type of charging connector.

The charging inlet assembly 100 includes a housing 110 holding a terminal assembly 112. The housing 110 and terminal assembly 112 define the receptacle connector 102. The terminal assembly 112 is configured to be mated to the charging connector. For example, the terminal assembly 112 is located in a socket(s) 114 of the housing 110 configured to receive the charging plug for mating to the charging connector. The housing 110 may include one or more walls 116 forming the socket(s) 114. In an exemplary embodiment, the terminal assembly 112 may be an AC terminal assembly, such as a level 1 charger or a level 2 charger. In other various embodiments, the terminal assembly 112 may be a DC terminal assembly having DC terminals for DC fast-charging.

The terminal assembly 112 includes a plurality of terminals 120 for mating with the charging connector. In the illustrated embodiment, five terminals 120 are provided, including first and second charging terminals 122 for carrying charging current, a ground terminal 124, a proximity pilot terminal 126, and a control pilot terminal 128. The proximity pilot terminal 126 confirms a proper connection between the charging connector and the charging inlet assembly 100 preventing charging if the connection is faulty. The control pilot terminal 128 handles two-way communication between the charging inlet assembly 100 and the charging connector, such as for negotiating charging parameters and reporting status. Other types of terminals may be provided in alternative embodiments. Greater or fewer terminals 120 may be provided in alternative embodiments. The terminals 120 may be different sized terminals. For example, the charging terminals 122 may be larger than the other terminals 120 to carry higher current.

In an exemplary embodiment, the housing 110 is a multi-piece housing. For example, the housing 110 includes a main housing body 130, a front mounting flange 132 at a front 134 of the housing 110, and a rear cover 136 at a rear 138 of the housing 110. The mounting flange 132 may include openings configured to receive fasteners for securing the housing 110 to the vehicle. Other types of mounting features may be used to secure the charging inlet assembly 100 to the vehicle. The mounting flange 132 may include a seal to seal the charging inlet assembly 100 to the vehicle. The mounting flange 132 is coupled to the main housing body 130, such as by fasteners, latches, clips, or other securing features. The rear cover 136 covers or encloses internal components of the charging inlet assembly 100 in the housing 110. The rear cover 136 is coupled to the main housing body 130, such as by fasteners, latches, clips, or other securing features. The housing 110 may include other components or housing elements in alternative embodiments. In other various embodiments, the mounting flange 132 may be integral with the main housing body 130, rather than being a separate structure.

The housing 110 has a depth 140 measured between the front 134 and the rear 138. The depth 140 is measured along the sides of the housing 110 defining an outer perimeter of the housing 110 between the front 134 and the rear 138, such as along a top 142, a bottom 144, a right side 146, and a left side 148. In an exemplary embodiment, the charging inlet assembly 100 is contained within a depth envelope. For example, the front 134 of the housing 110 defines a front of the charging inlet assembly 100 and a rear 138 of the housing 110 defines a rear of the charging inlet assembly 100. In an exemplary embodiment, no portion of the charging inlet assembly 100 extends forward of the front 134. In an exemplary embodiment, no portion of the charging inlet assembly 100 extends rearward of the rear 138. As such, the rear 138 may be seated against the vehicle. For example, the charging inlet assembly 100 may be received in a pocket or opening in the vehicle without having other components interfere with or bottom out in the pocket of the vehicle. The housing 110 has a low-profile in the depth dimension. For example, the depth is the smallest dimension, such as being smaller than the height and the width of the housing 110. In an exemplary embodiment, the rear 138 is flat or planar. Connectors, wires, cables, and other components do not extend from the rear 138.

In an exemplary embodiment, the housing 110 includes terminal channels 150 that receive the corresponding terminals 120. The terminal channels 150 pass through an end wall 152 of the housing 110. The terminal channels 150 may pass through the main housing body 130. The housing 110 may include latches or other elements to secure the terminals 120 in the terminal channels 150. Portions of the terminals 120 may extend forward of the end wall 152, such as into the sockets 114. In an exemplary embodiment, the terminals 120 include pins 154 at mating ends of the terminals 120. The pins 154 extend into the socket 114 for mating with the charging connector.

In an exemplary embodiment, the charging inlet assembly 100 includes a control module 200 electrically coupled to the terminal assembly 112. The control module 200 facilitates communication, control, and safety functions during the charging process. The control module 200 may be communicatively coupled to another component within the vehicle, such as the battery control module. The control module 200 may manage the interaction between the charging station and the vehicle, ensuring a safe and efficient charging experience. For example, the control module 200 enables communication between the charging station and the vehicle's onboard systems for exchanging information about the charging status, battery level, and other relevant data. The control module 200 may control the charging process, ensuring the battery receives the correct amount of power and voltage and preventing overcharging or other issues that could damage the vehicle or charging equipment. The control module 200 may trigger safety mechanisms like locking the charging plug into the inlet to prevent accidental disconnection or tampering during charging.

In an exemplary embodiment, the control module 200 is contained within the depth of the housing 110, such as being located rearward of the front 134 and forward of the rear 138. For example, the control module 200 is coupled to a control module interface 202 at a side of the housing 110, such as the top 142 of the housing 110. The control module 200 is located at the outer periphery of the housing 110. The control module 200 does not add to the overall depth of the charging inlet assembly 100. For example, the housing and cables of the control module 200 do not protrude rearwardly from the housing 110. The control module 200 does not protrude rearward from the charging inlet assembly 100, thus allowing fitting of the charging inlet assembly in a small depth compartment or pocket within the vehicle.

In an exemplary embodiment, the charging inlet assembly 100 includes a charging module 300 electrically coupled to the terminal assembly 112. The charging module 300 is configured to be electrically connected to the battery system of the vehicle. The charging current is transferred from the charging inlet assembly 100 to the battery system through the charging module 300. In an exemplary embodiment, the charging module 300 includes a module housing 310 and charging cables 320 extending from the module housing 310. The charging cables 320 extend from a cable end of the module housing 310. A mating end of the module housing 310 is coupled to the housing 110 of the charging inlet assembly 100, such as to a charging module interface 302 of the housing 110. In the illustrated embodiment, the charging module interface 302 is located at the side 146 of the housing 110; however, the charging module interface may be located at another side of the housing 110, such as the top 142, the bottom 144 or the opposite side 148.

The module housing 310 may hold contacts or terminals, such as ring terminals, crimp terminals, or other types of terminals that are coupled to the corresponding terminals 120 of the terminal assembly 112 and are configured to be terminated to the charging cables 320. In an exemplary embodiment, cable covers 322 are provided. The cable covers 322 are coupled to a cable end of the module housing 310. The cable covers 322 provide strain relief for the charging cables 320. The cable covers 322 may hold seals to seal to the module housing 310 and/or the charging cables 320.

In an exemplary embodiment, the charging module 300 is contained within the depth of the housing 110, such as being located rearward of the front 134 and forward of the rear 138. For example, the charging module 300 extends from the charging module interface 302 at the side of the housing 110. The charging module 300 does not add to the overall depth of the charging inlet assembly 100. For example, the module housing 310 and charging cables 320 of the charging module 300 do not protrude rearwardly from the housing 110. The charging module 300 does not protrude rearward from the charging inlet assembly 100, thus allowing fitting of the charging inlet assembly in a small depth compartment or pocket within the vehicle.

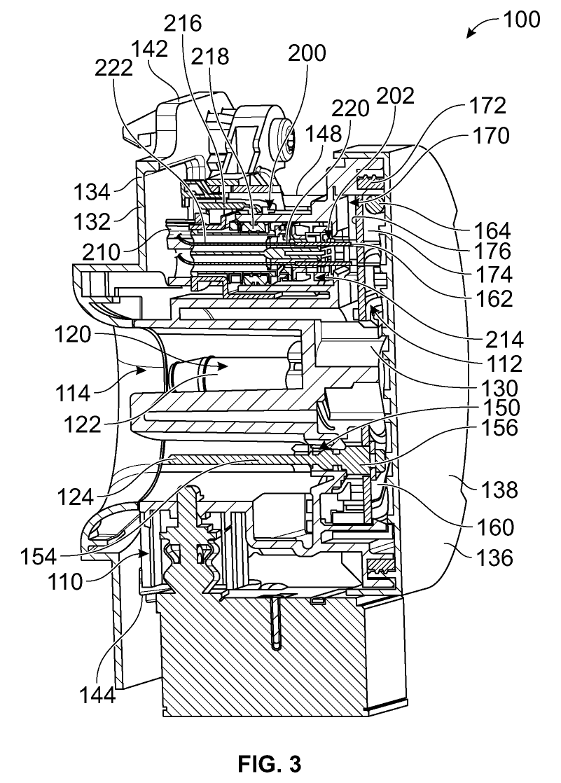

FIG. 3 is a sectional view of the charging inlet assembly 100 in accordance with an exemplary embodiment. The charging inlet assembly 100 includes the housing 110 and the terminal assembly 112 coupled to the housing 110. The housing 110 includes the main housing body 130, the front mounting flange 132 at the front 134 of the housing 110, and the rear cover 136 at the rear 138 of the housing 110. The housing 110 holds the terminals 120 in the terminal channels 150.

In an exemplary embodiment, the terminal assembly 112 includes a printed circuit board 160. Some or all of the terminals 120 may be coupled to the printed circuit board 160. The terminal assembly 112 includes mating contacts 162 extending from the printed circuit board 160. The mating contacts 162 may be electrically connected to the terminals 120, such as the ground terminal 124, and/or the proximity pilot terminal 126, and/or the control pilot terminal 128. In various embodiments, the terminal assembly 112 includes one or more sensors 164 coupled to the printed circuit board 160. The sensors 164 may include temperature sensors, voltage sensors, current sensors, or other types of sensors. The mating contacts 162 may be electrically connected to the sensors 164. The mating contacts 162 are configured to be electrically connected to the control module 200 at the control module interface 202.

In an exemplary embodiment, the printed circuit board 160 is received in a rear chamber 170 at the rear 138 of the housing 110. In the illustrated embodiment, the rear chamber 170 is formed in the main housing body 130. The rear cover 136 covers the rear chamber 170. In an exemplary embodiment, a seal 172 is received in the rear chamber 170 that is sealed to the rear cover 136 and the main housing body 130. In the illustrated embodiment, the printed circuit board 160 is oriented vertically within the rear chamber 170. A rear surface 174 of the printed circuit board 160 faces the rear cover 136. A front surface 176 of the printed circuit board 160 is forward facing. In the illustrated embodiment, the mating contacts 162 extend forward from the front surface 176 of the printed circuit board 160. Other orientations are possible in alternative embodiments.

In an exemplary embodiment, each terminal 120 includes a base 156 and a rear end of the terminal 120 and the pin 154 at a front end of the terminal 120. The pin 154 extends forward from the base 156 into the socket 114 for mating with the charging connector. The base 156 and/or the pin 154 may be received in the terminal channel 150. The base 156 may be coupled to the printed circuit board 160. In other various embodiments, the base 156 may be terminated to the corresponding charging cable 320 (shown in FIG. 2). For example, the bases 156 of the first and second charging terminals 122 and the ground terminal 124 may be terminated to the corresponding charging cables 320, such as by ring terminals or other intervening terminals or contacts, whereas the bases 156 of the proximity pilot terminal 126 and the control pilot terminal 128 are terminated to the printed circuit board 160. The base 156 of the ground terminal 124 may additionally be terminated to the printed circuit board 160.

The control module 200 is electrically coupled to the terminal assembly 112. In an exemplary embodiment, the control module 200 includes a connector housing 210, control contacts 220 held by the housing 210, and control wires 222 extending from the control contacts 220. The control cables 222 extend from a cable end 212 of the connector housing 210 and are routed away from the charging inlet assembly 100, such as to another system or component within the vehicle. A mating end 214 of the connector housing 210 is coupled to the housing 110 of the charging inlet assembly 100, such as to the control module interface 202 of the housing 110. The control contacts 220 are coupled to the mating contacts 162 at the mating end 214. In the illustrated embodiment, the control contacts 220 extend parallel to the mating contacts 162 and are mated along a mating axis that is perpendicular to the printed circuit board 160. In the illustrated embodiment, the control module 200 is located forward of the printed circuit board 160.

In an exemplary embodiment, the control module 200 includes a latch 216 configured to be latchably coupled to the housing 110. The control module 200 may be secured to the housing 110 by other means in alternative embodiments. In an exemplary embodiment, the control module 200 includes a seal 218 configured to be sealed to the housing 110.

In an exemplary embodiment, the control module 200 is contained within the depth of the housing 110, such as being located rearward of the front 134 and forward of the rear 138. For example, the control module 200 is coupled to the control module interface 202 at the top 142 of the housing; however, the control module interface 202 may be located at another side of the housing 110, such as the bottom 144 or one of the right or left sides 146, 148. The control module 200 is located at the outer periphery of the housing 110. The control module 200 does not add to the overall depth of the charging inlet assembly 100. For example, the connector housing 210 and the control wires 222 do not protrude rearwardly from the housing 110.

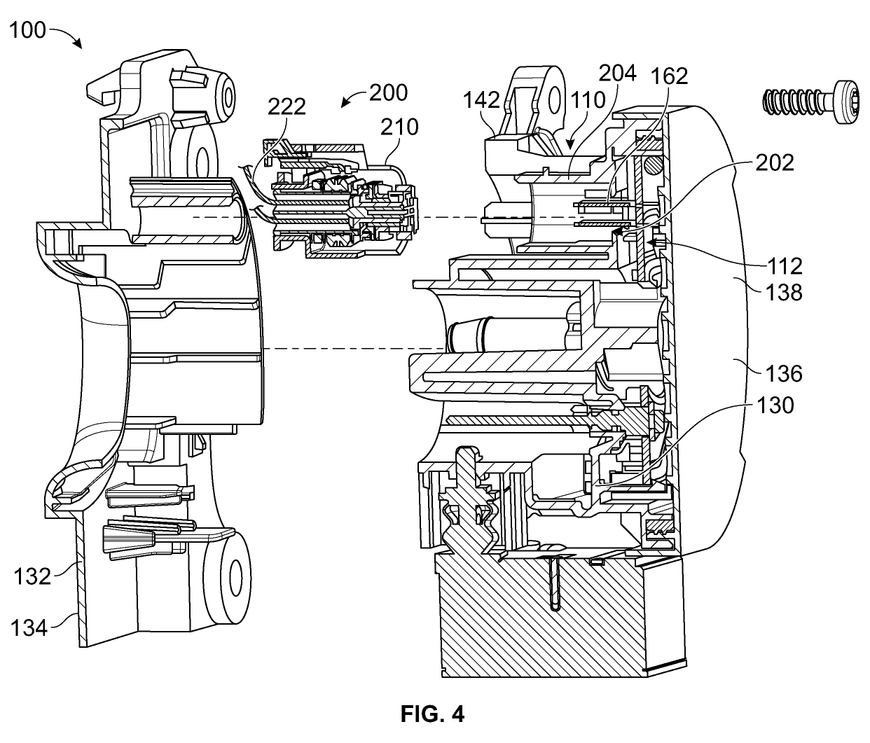

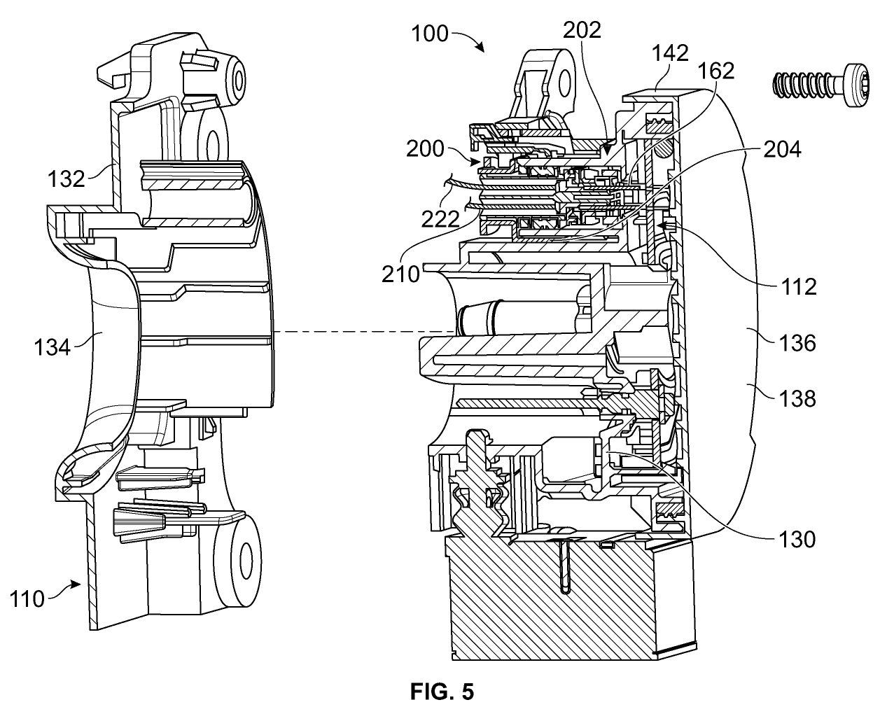

FIG. 4 is an exploded view of the charging inlet assembly 100 in accordance with an exemplary embodiment. FIG. 5 is an exploded, partially assembled view of the charging inlet assembly 100 in accordance with an exemplary embodiment. FIGS. 4 and 5 show the terminal assembly 112 coupled to the housing 110. FIG. 4 shows the control module 200 poised for coupling to the terminal assembly 112 and the housing 110. FIG. 5 shows the control module 200 coupled to the terminal assembly 112 and the housing 110.

In an exemplary embedment, the housing 110 includes a shroud 204 at the control module interface 202. The mating contacts 162 extend into the shroud 204. The control module 200 is coupled to the shroud 204. In the illustrated embodiment, the shroud 204 is forward facing. The control module 200 is mated to the shroud 204 in a rearward mating direction. In an exemplary embodiment, when assembled, the control module 200 is configured to be captured between the shroud of the main housing body 130 and the front mounting flange 132. The control wires 222 exit the control module 200 in the space between the front mounting flange 132 and the connector housing 210. The control module 200 is contained within the depth of the housing 110, such as being located rearward of the front 134 and forward of the rear 138. The control module 200 is located at the outer periphery of the housing 110, such as at the top 142. The control module 200 does not add to the overall depth of the charging inlet assembly 100. For example, the connector housing 210 and the control wires 222 do not protrude rearwardly from the housing 110.

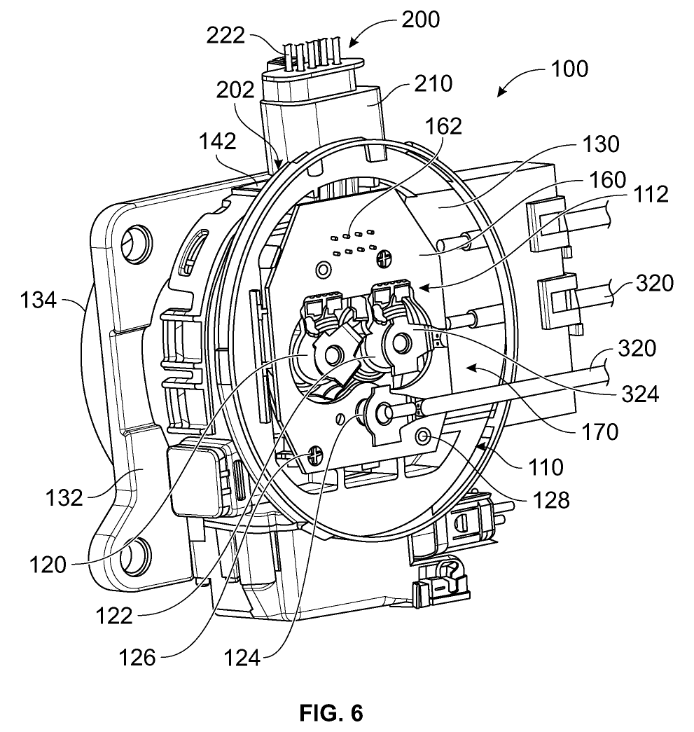

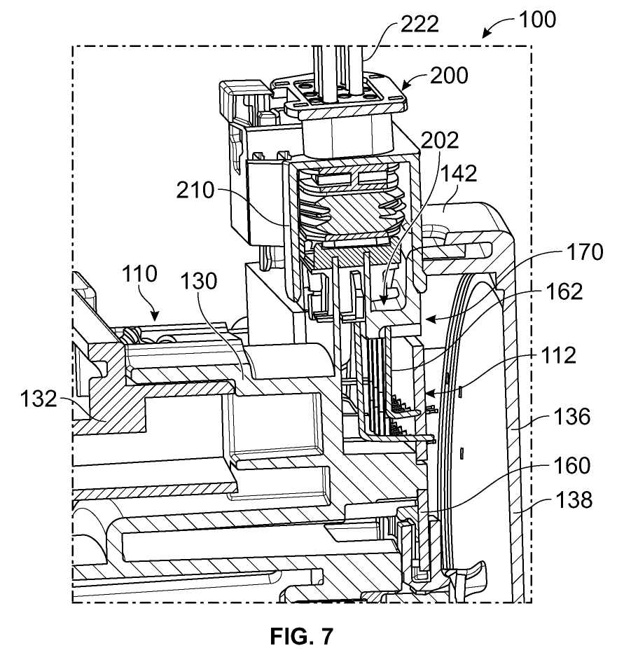

FIG. 6 is a rear perspective view of a portion of the charging inlet assembly 100 in accordance with an exemplary embodiment.FIG. 7 is a sectional view of the charging inlet assembly 100 shown in FIG. 6. The charging inlet assembly 100 includes the housing 110 and the terminal assembly 112 coupled to the housing 110. The housing 110 includes the main housing body 130, the front mounting flange 132 at the front 134 of the housing 110, and the rear cover 136 (FIG. 7) at the rear 138 of the housing 110. The housing 110 holds the printed circuit board 160 in the rear chamber 170. The control module 200 is electrically connected to the terminal assembly 112 at the control module interface 202.

The terminal assembly 112 includes the mating contacts 162 extending from the printed circuit board 160. In the illustrated embodiment, the mating contacts 162 are right angle contacts. For example, mating ends of the mating contacts 162 are oriented 90° relative to mounting ends of the mating contacts 162, which are mounted to the printed circuit board 160. The mating ends of the mating contacts 162 are mated to the control contacts 220 along a mating axis that is parallel to the printed circuit board 160. For example, in the illustrated embodiment, the control module interface 202 is at the top 142 of the housing 110 and the control module 200 is configured to be mated in a vertically downward mating direction. The mating contacts 162 are electrically connected to corresponding terminals 120, such as the ground terminal 124, the proximity pilot terminal 126, and the control pilot terminal 128. The first and second charging terminals 122 may pass through an opening in the printed circuit board 160 and are configured to be electrically connected to the charging cables 320, such as via ring terminals 324 (FIG. 6).

The control module 200 is contained within the depth of the housing 110, such as being located rearward of the front 134 and forward of the rear 138. The control module 200 is located at the outer periphery of the housing 110, such as at the top 142. The control module 200 does not add to the overall depth of the charging inlet assembly 100. For example, the connector housing 210 and the control wires 222 do not protrude rearwardly from the housing 110.

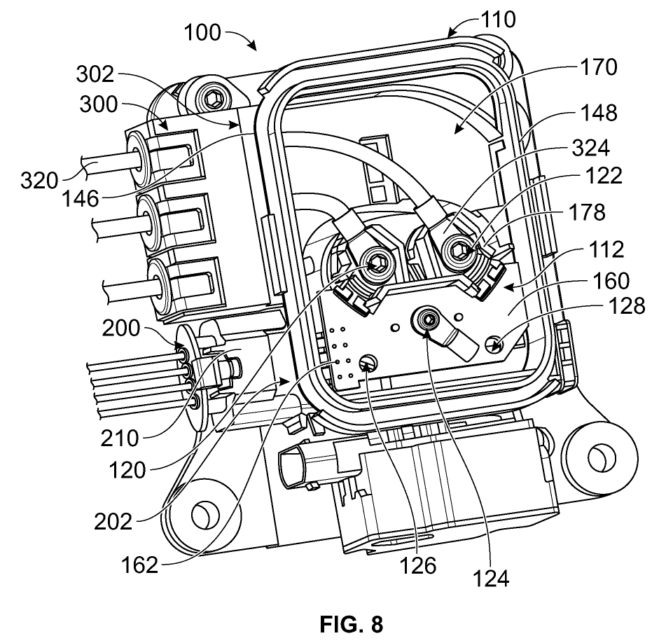

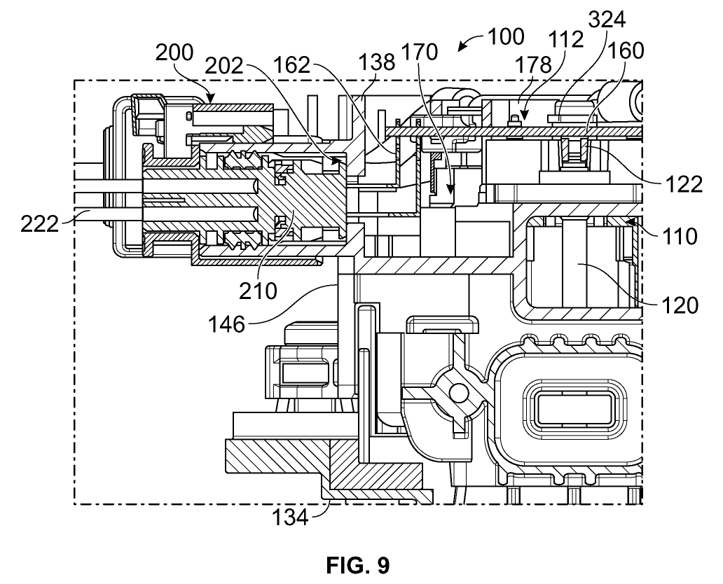

FIG. 8 is a rear perspective view of a portion of the charging inlet assembly 100 in accordance with an exemplary embodiment. FIG. 9 is a sectional view of the charging inlet assembly 100 shown in FIG. 8. The charging inlet assembly 100 includes the housing 110 and the terminal assembly 112 coupled to the housing 110. The housing 110 holds the printed circuit board 160 in the rear chamber 170. The control module 200 is electrically connected to the terminal assembly 112 at the control module interface 202.

The terminal assembly 112 includes the mating contacts 162 extending from the printed circuit board 160. In the illustrated embodiment, the mating contacts 162 are right angle contacts. For example, mating ends of the mating contacts 162 are oriented 90° relative to mounting ends of the mating contacts 162, which are mounted to the printed circuit board 160. The mating ends of the mating contacts 162 are mated to the control contacts 220 along a mating axis that is parallel to the printed circuit board 160. The mating contacts 162 are electrically connected to corresponding terminals 120, such as the ground terminal 124, the proximity pilot terminal 126, and the control pilot terminal 128 via the printed circuit board 160.

In an exemplary embodiment, the first and second charging terminals 122 are received in terminal supports 178 in the rear chamber 170. The terminal supports 178 may directly support the charging terminals 122 and/or may support the ring terminals 324. In an exemplary embodiment, the terminal supports 178 may guide the exit angles of the charging cables 320, such as to avoid short circuiting or arcing. The housing 110 may include other features to guide routing of the charging cables 320 and/or the ring terminals 324.

In the illustrated embodiment, the control module interface 202 is at the side 146 of the housing 110 and the control module 200 is configured to be mated in a horizontal mating direction. The control module interface 202 may be at the same side as the charging module interface 302. For example, both the control module 200 and the charging module 300 may be coupled to the housing 110 at the same side 146. In alternative embodiments, the control module 200 and the charging module 300 may be coupled to the housing 110 at the opposite sides 146, 148.

The control module 200 is contained within the depth of the housing 110, such as being located rearward of the front 134 and forward of the rear 138. The control module 200 is located at the outer periphery of the housing 110, such as at the side 146. The control module 200 does not add to the overall depth of the charging inlet assembly 100. For example, the connector housing 210 and the control wires 222 do not protrude rearwardly from the housing 110.

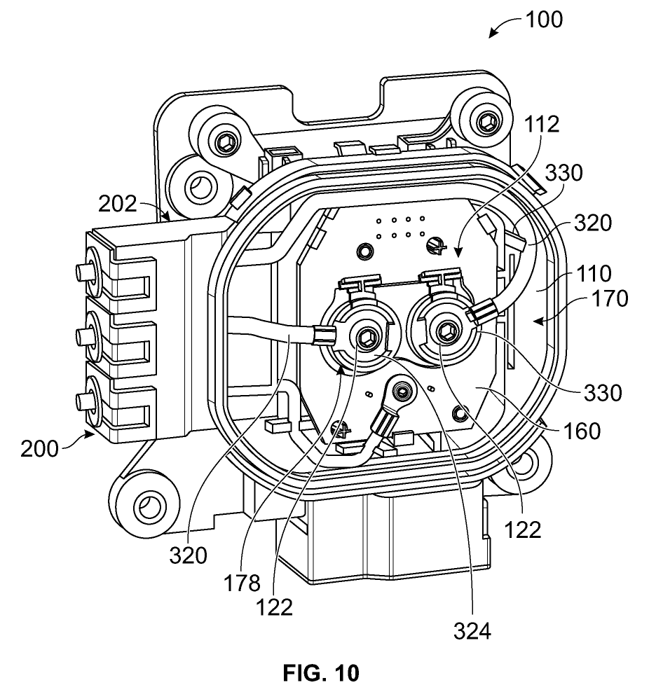

FIG. 10 is a rear perspective view of a portion of the charging inlet assembly 100 in accordance with an exemplary embodiment. The charging inlet assembly 100 includes the housing 110 and the terminal assembly 112 coupled to the housing 110. The housing 110 holds the printed circuit board 160 in the rear chamber 170. The control module 200 is electrically connected to the terminal assembly 112 at the control module interface 202.

In an exemplary embodiment, the first and second charging terminals 122 are received in terminal supports 178 in the rear chamber 170. The terminal supports 178 may directly support the charging terminals 122 and/or may support the ring terminals 324. In an exemplary embodiment, the terminal supports 178 may guide the exit angles of the charging cables 320, such as to avoid short circuiting or arcing. In an exemplary embodiment, the housing 110 includes cable guides 330 to guide routing of the charging cables 320 in the rear chamber 170. The cable guides 330 may be walls, tabs, clips, or other features that interface with and position the charging cables 320 in the rear chamber 170. The charging cables 320 are routed in the rear chamber 170 in a controlled manner, such as to limit cable bending and/or separation distance between the components, such as to control arc distancing.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, in the following claims, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A charging inlet assembly comprising:
a housing extending between a front and a rear, the housing having a depth between the front and the rear, the housing defining a receptacle connector at the front configured for mating reception of a charging connector, the housing having a chamber at the rear, the housing having a terminal channels between the front and the rear;
a terminal assembly coupled to the housing, the terminal assembly including a plurality of terminals for mating with charging terminals of the charging connector, the terminals received in corresponding terminal channels, each terminal including a base and a pin extending forward from the base; and
a control module electrically coupled to the terminal assembly, the control module including a connector housing coupled to the housing, the control module contained within the depth of the housing located rearward of the front and forward of the rear of the housing.

2. The charging inlet assembly of claim 1, wherein the connector housing includes a mating end and a cable end, the control module including control contacts held by the connector housing and cables coupled to the control contacts and extending from the cable end, the mating end and the cable end being contained within the depth of the housing located rearward of the front and forward of the rear of the housing.

3. The charging inlet assembly of claim 2, wherein the mating end is at a rear of the control module and the cable end is at a front of the control module.

4. The charging inlet assembly of claim 2, wherein the mating end is at a bottom of the control module and the cable end is at a top of the control module, the control module being coupled to a top of the housing.

5. The charging inlet assembly of claim 2, wherein the mating end is at a first side of the control module and the cable end is at a second side of the control module, the control module being coupled to a side of the housing at a perimeter of the housing.

6. The charging inlet assembly of claim 1, wherein the housing includes a rear cover coupled to and covering the rear of the housing, the housing including a mounting flange at the front of the housing configured to be mounted to a vehicle, the control module being located between the mounting flange and the rear cover.

7. The charging inlet assembly of claim 1, wherein the control module includes cables extending therefrom, the cables exiting from a side of the housing between the front and the rear.

8. The charging inlet assembly of claim 7, wherein the housing includes cable guides in the chamber to control routing of the cables in the chamber.

9. The charging inlet assembly of claim 1, wherein the housing includes a side between the front and the rear, the housing including a control module interface at the side, the control module being coupled to the housing at the control module interface.

10. The charging inlet assembly of claim 1, wherein the terminal assembly includes a printed circuit board located in the chamber, the terminals being coupled to the printed circuit board, the control module being electrically connected to the printed circuit board.

11. The charging inlet assembly of claim 10, wherein the printed circuit board includes mating contacts extending therefrom, the control module including control contacts coupled to the corresponding mating contacts at separable mating interfaces.

12. The charging inlet assembly of claim 10, wherein the control module is coupled to a front of the printed circuit board.

13. The charging inlet assembly of claim 1, further comprising a charging module electrically coupled to the terminal assembly, the charging module including a module housing coupled to the housing, the charging module contained within the depth of the housing located rearward of the front and forward of the rear of the housing.

14. The charging inlet assembly of claim 13, wherein the terminals of the terminal assembly includes charging terminals, a ground terminal, a control pilot terminal, and a proximity pilot terminal, the charging terminals being electrically connected to the charging module, the ground terminal, the control pilot terminal, and the proximity pilot terminal the coupled to the control module.

15. A charging inlet assembly comprising:
a housing extending between a front and a rear, the housing having a depth between the front and the rear, the housing defining a receptacle connector at the front configured for mating reception of a charging connector, the housing having a chamber at the rear, the housing having a terminal channels between the front and the rear;
a terminal assembly coupled to the housing, the terminal assembly including a plurality of terminals for mating with charging terminals of the charging connector, the terminals received in corresponding terminal channels, each terminal including a base and a pin extending forward from the base, the terminal assembly including a printed circuit board, the bases of the terminals being coupled to the printed circuit board, the terminal assembly including mating contacts extending from the printed circuit board; and
a control module electrically coupled to the terminal assembly, the control module including a connector housing holding control contacts, the connector housing coupled to the housing, the control contacts coupled to the corresponding mating contacts to electrically connect to the printed circuit board, the control module contained within the depth of the housing located rearward of the front and forward of the rear of the housing.

16. The charging inlet assembly of claim 15, wherein the mating contacts extend forward from a front of the printed circuit board, the control module coupled to a mating interface located between the front of the printed circuit board and the front of the housing.

17. The charging inlet assembly of claim 15, wherein the mating contacts are right angle contacts having mounting ends extending from the printed circuit board and mating ends for mating with the control contacts, the mating ends oriented perpendicular to the mounting ends.

18. The charging inlet assembly of claim 15, wherein the connector housing includes a mating end and a cable end, the control module including cables coupled to the control contacts and extending from the cable end, the mating end and the cable end being contained within the depth of the housing located rearward of the front and forward of the rear of the housing.

19. The charging inlet assembly of claim 15, wherein the housing includes a rear cover coupled to and covering the rear of the housing, the housing including a mounting flange at the front of the housing configured to be mounted to a vehicle, the control module being located between the mounting flange and the rear cover.

20. The charging inlet assembly of claim 15, further comprising a charging module electrically coupled to the terminal assembly, the charging module including a module housing coupled to the housing, the charging module contained within the depth of the housing located rearward of the front and forward of the rear of the housing.

21. A charging inlet assembly comprising:
a housing extending between a front and a rear, the housing including a rear cover coupled to and covering the rear of the housing, the housing including a mounting flange at the front of the housing configured to be mounted to a vehicle, the housing defining a receptacle connector at the front configured for mating reception of a charging connector, the housing having a chamber at the rear, the housing having a terminal channels between the front and the rear;
a terminal assembly coupled to the housing, the terminal assembly including a plurality of terminals for mating with charging terminals of the charging connector, the terminals received in corresponding terminal channels, each terminal including a base and a pin extending forward from the base; and
a control module electrically coupled to the terminal assembly, the control module including a connector housing coupled to the housing, the control module being located between the mounting flange and the rear cover.
